(19) United States
(12) Patent Application Publication
(10) Pub. No.: US 2020/0170457 A1
(43) Pub. Date: Jun. 4, 2020

(54) POSITIVE PRESSURE SOAP DISPENSER APPARATUS

(71) Applicant: The Board of Regents for the Oklahoma Agricultural and Mechanical Colleges, Stillwater, OK (US)

(72) Inventor: Aaron Scott Alexander, Glencoe, OK (US)

(21) Appl. No.: 16/701,337

(22) Filed: Dec. 3, 2019

Related U.S. Application Data
(60) Provisional application No. 62/774,415, filed on Dec. 3, 2018.

(51) Int. Cl. A47K 5/12; B05B 11/00

(52) U.S. Cl. CPC A47K 5/1211; B05B 11/007; B05B 11/3028; B05B 11/00412

(57) ABSTRACT

According to an embodiment, a container containing fluid fitted with a cap that contains a one-way valve that is placed on the upstream opening of a dispensing nozzle. Dispensed fluid is expressed by compressing the flexible walls of the container which serves to open the dispensing nozzle valve. An air recovery vent will be placed in the cap in order to allow the internal and external pressure to equalize after the contents have been partially dispensed. The vent may optionally be channeled up into the container away from the container terminus by use of a small extension tube. The exit of the vent hole/tube contains another one-way valve which prevents backflow of fluid and air while allowing air to enter the container. Thus, the flow of product out of the container and air into the container are both unidirectional.

### CROSS REFERENCE TO RELATED APPLICATIONS

This application claims the benefit of U.S. Provisional Patent Application Ser. No. 62/774,415 filed on Dec. 3, 2018, and incorporates said provisional application by reference into this document as if fully set out at this point.

### TECHNICAL FIELD

This disclosure relates generally to fluid dispensers and, more specifically, dispensers for fluids or gels with a higher viscosity than water.

### BACKGROUND

Fluid dispensers (soap, lotion, condiments, etc.) typically use a negative pressure pump to pull the fluid up a pipe in order to dispense it to the user or invert the container with a cap on the bottom to prevent leakage. The pump solution often results in a substantial amount of fluid being left in the bottom of the container that cannot be reached by the dispensing pipe. The user then has to choose between wasting the leftover amount by throwing away the container or attempting to the drain the remaining bit manually. Additionally, the pump uses a great deal of material and has multiple components (e.g., about 11 in some cases). Pump dispensers occupy excess vertical space which results in greater expense in packaging, shipping, and shelving the dispenser.

Another approach has been to add a mechanical cap to the bottom of the container that contains a flat flip top or similar arrangement that can be opened and closed to allow fluid to escape. Of course, since the container is stored with its cap at the bottom gravity tends to urge the contents of the container toward its discharge orifice. This arrangement makes it possible to readily eject the stored contents by squeezing the container which results in minimum wasted product. This sort of cap is designed to prevents fluid from leaking out of the container when closed, but flow freely when open. However, a bottom cap can be inconvenient to open and close and can become soiled with the contents of the container if the cap is not promptly closed after it is used or if it leaks.

On the other hand, the negative pressure pump requires the user to push down on the pump in order to pull fluid up a pipe. This is more convenient to use than the openable cap, but pushing down on the pump can often destabilize the container, knocking it over which is another disadvantage of this type of dispenser.

Thus, what is needed is a fluid dispenser that does not suffer from the disadvantages of the prior art approaches.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

The invention herein uses positive pressure and an inverted container so that the all of the fluid material in the container is dispensed. Leaks are prevented by application of one-way valves so that a cap is unnecessary for the system.

According to an embodiment, there is provided a cap for a flexible container containing fluid that permits the container to be stored in an inverted position so that the fluid drains down into the cap. To prevent the fluid from prematurely dispensing, a one-way valve (e.g., a duckbill valve, an umbrella valve, or other one-way valve) is placed on the upstream opening of a dispensing nozzle. Dispensed fluid is expressed by compressing the flexible walls of a container which leaves a partial vacuum in the container that is replaced with the same volume of air. So, an air recovery vent will be placed in the cap in order to allow the internal and external pressure to equalize. In some embodiments, the dispensing valve may be located on the exterior of the cap. In this embodiment, the dispensing valve might be made rotatable so that it can be rotated between an open and a closed position. This variation might be especially useful during shipping to further insure that the contents don't leak and to save space during transportation and when placed on the seller's shelves.

The inside terminus of the vent may optionally be channeled up into the interior of container through the use of a small tube. The exit of the vent hole/tube contains another one-way valve preventing backflow of fluid and air while allowing air to enter the container to equalize the pressure inside and out. Thus, the flow of product out of the container and air into the container are both unidirectional.

When the container is squeezed the interior is pressurized. This closes the one-way valve on the air-intake vent while opening the one-way valve on the dispenser nozzle allowing the fluid contents to be dispensed. When the sides of the container are released they recover, thereby creating a partial vacuum inside the container. This closes the one-way valve on the dispensing nozzle and opens the one-way valve on the vent pulling air into the container.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 shows a perspective view of one embodiment of the instant dispenser.

FIG. 2 contains a plan view of the dispenser embodiment of FIG. 1.

FIG. 3 contains a perspective view of the dispenser embodiment of FIG. 1.

FIG. 4 contains another angular view of an embodiment of FIG. 1, which shows one exit port for a dispensing aperture.

FIG. 5 contains a cross sectional view of the embodiment of FIG. 1.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

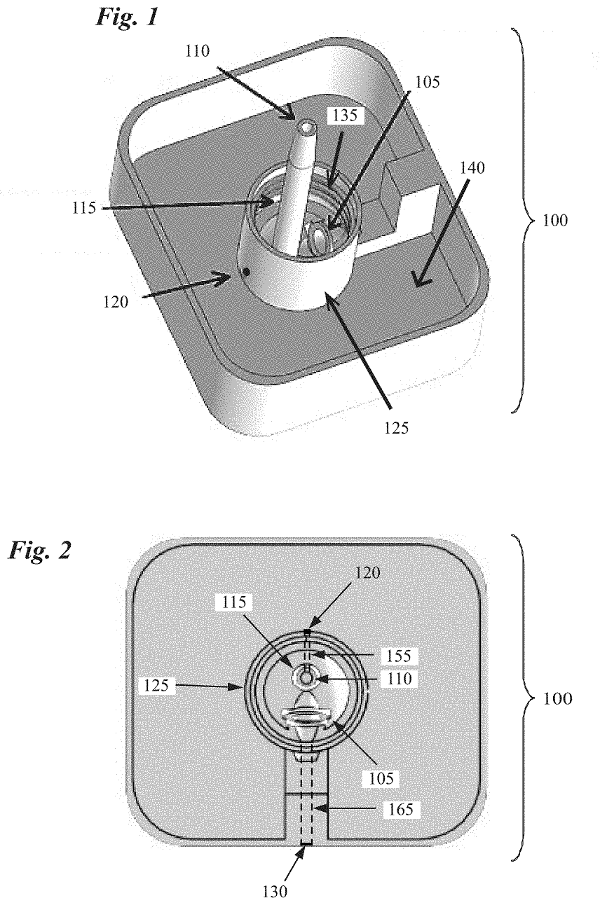

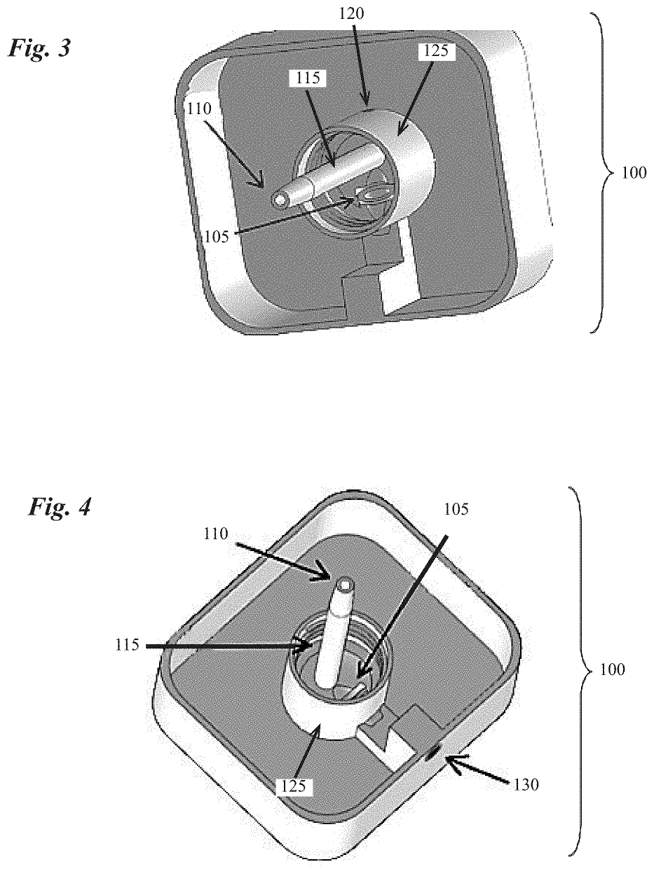

The embodiment of FIGS. 1-4 act as a cap 100 to a fluid or gel (the product) dispensing container which is preferably stored in an inverted orientation. The cap 100 serves as a base to the inverted container so it may be inverted without dispensing its contents until a user compresses the elastic sides of the container as is conventionally done. The lower face of the cap 100 should be substantially flat so that the container can stand in an inverted orientation. This arrangement means that the contents of the container are always ready to be dispensed. Additionally, this arrangement is designed to minimize the wasted product that might remain in the container when it is almost empty. The operation of the instant cap 100 will be described in greater detail below. Note that when it is said that the lower face of the cap 100 is “flat” it should be understood that means that it is configured so that after it is installed on the container that contains the liquid that is to be dispensed, that container may be stored in an inverted orientation. Thus, a cap 100 that has an embossed design on its lower face, a plurality of nubs or other protrusions that serve as legs should be understood to still be within the definition of “flat” for purposes of the instant disclosure.

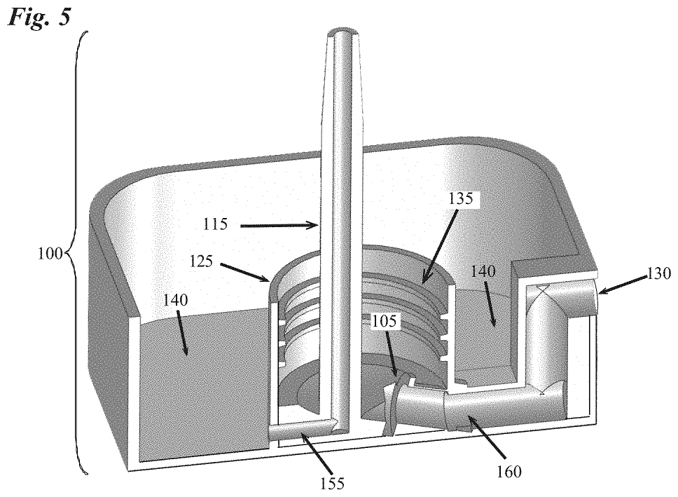

FIG. 1 shows a perspective view of one embodiment of a cap 100 for use with an inverted liquid dispenser. In the current embodiment, one-way dispensing valve 105 is provided which is in fluid communication with the contents of the contents of the attached container. To prevent the contents of the container from dispensing prematurely, this valve 105 (e.g., a duckbill valve, an umbrella valve, etc.) is placed in the dispensing path. FIG. 1 shows one possible location of the dispensing valve 105. One-way dispensing valve 105 is designed to control access to a conduit 160 (shown FIG. 2 and FIG. 5) which terminates in dispensing aperture 130. When sufficient compression is applied to the walls of an attached container to create a pressure in the container that exceeds the threshold opening pressure of the valve 105, it opens to allow the contents of the container to exit through dispensing aperture 130. However, when pressure on the container is released, the elastic walls of the container will tend to move outward thereby creating a partial vacuum which will cause the dispensing valve 105 to close, which closure acts to keep the contents of the container from entering the conduit.

In some embodiments, the dispensing valve may be located on the exterior of the cap and placed in fluid communication with the container contents by way of a conduit of some sort. It might extend either horizontally from the side of the cap or vertically downward from its lower surface. In this embodiment, the dispensing valve might be made to be rotatable between an open and a closed configuration. This would allow the fluid communication between the dispensing valve and interior of the container to be blocked when the contents of the container are not intended to be dispensed. This variation might be especially useful if it is extended from the flat underside side of the cap since otherwise the container would not be able to be stored upright and in an inverted position. In general, though, having a rotatable dispensing valve could be of value during shipping since that would provide an additional guard against leakage of the contents. If the dispensing valve extended horizontally from the side of the cap, having it rotatable to be in a vertical orientation would act to save space during transportation and when placed on the seller's shelves.

As should clear, in the embodiment of FIG. 1, threads 135 are provided on the inner surface of attaching member 125 which provide a means for secure attachment of a container (not shown) that contains the liquid that is to be disbursed. That is, in some embodiments the attaching member 125 will be a threaded cylinder as is generally illustrated in the figures. In some embodiments the attaching member 125 will be removably attached to the container. In other embodiments, it will be permanently or semi-permanently attached.

The attaching member 125 is designed to create a seal between the cap 100 and the container sufficient to contain the liquid in the container when the cap 100 is installed on the container. In some embodiments the means of attachment of the cap 100 to the container will be via a threaded connection 135 on the interior of the attaching member 125. That being said, those of ordinary skill in the art will readily understand that there are any number of means of attaching a container to the instant cap 100 are possible and such a skilled individual will readily be able to design alternative methods of attachment. Additionally, it should be noted that plastic is one elastic material that is suitable for use in forming the container but those of ordinary skill in the art will recognize that plastic is just one example of the sorts of material that might be used and other elastic materials that are impervious to the liquid intended to be contained within could also be used. Thus, when the term “flexible container” is used herein it should be understood to be any sort of container for holding a liquid with sides that are elastic and compressible an amount sufficient to expel at least a portion of its contents.

As noted previously, when the sides of the container are compressed its internal volume is decreased and pressure is exerted on the liquid contained therein which urges it toward the dispensing nozzle 130 which functions as a pressure release mechanism when opened. When the side walls of the container rebound after the compression event is ended, that creates a partial vacuum internally which must be relieved in order for the container to continue to effectively dispense liquid.

In that regard, an air recovery vent 120 is placed in the attaching member 125 of the cap to allow for entry of air. The air recovery vent 120 is in fluid communication with the exterior of the cap through air recovery conduit 155 (shown in FIG. 2 and FIG. 5) and with air recovery valve 110 (not shown in FIG. 5), the terminus of which is situated inside of the container. Thus, air can enter the container via the air recovery vent 120/air recovery valve 110 to relieve the vacuum created by the expulsion of the fluid therein. The air recovery valve 110 is a unidirectional/one-way valve that will allow air into the container once the air pressure differential exceeds its threshold opening pressure but is closed once the air pressure inside of the container is at least approximately equal to the ambient air pressure. This prevents fluid in the container from escaping via this route. Air recovery valve 110 in some embodiments is elevated above the inner surface 140 of the cap 100 through the use of an optional vent extension tube 115 which, in this embodiment, is a hollow tube.

In operation, when the container is squeezed the interior is pressurized. This shuts the one-way air recovery valve 110 in the air recovery path while opening the one-way valve 105 that is in fluid communication with the dispensing nozzle 130 via conduit 160 which causes fluid to be dispensed. When the container is released it recovers elastically which reduces the pressure inside the container. This shuts the one-way valve 105 on the dispensing path and opens the one-way air recovery valve 110 in the air recovery path which allows air to be pulled into the container.

In various embodiments, the material properties (including, but not limited to the container or cap material stiffness, the diameter of the dispensing and air intake channels, etc.), and valve shape can be tuned to provide the desired flow for fluid materials of differing densities and viscosities. Those of ordinary skill in the art will readily be able to adjust these, and other, parameters to suit the particular liquid that is to be dispensed.

In one embodiment the external apertures for the air recovery path (110/155/120) and the dispensing path (105/160/130) are placed in close proximity with each other so that both may be sealed by a single adhesive seal to prevent leakage of the product before delivery of the container to the end user. The end user will then remove the adhesive seal in order to use the product.

In another embodiment the one-way valve 105 on the dispensing path (105/160/130) may be situated proximate to the dispensing aperture 130. In this embodiment, the one-way valve 105 could be lengthened and shaped to act as a dispensing nozzle as well as a one-way valve. In this embodiment, the one-way valve nozzle 105 could be designed so that it folds down to allow an adhesive seal to be applied over it in order to prevent leakage of the product before the container is delivered to the end user. The end user will then remove the adhesive seal in order to use the product.

It should be noted that although soap would be a suitable material for inclusion in the container in various embodiments of the invention, any sort of liquid or gel including, by way of example only, liquids such as shampoos, lotions, styling gel, etc., might be used. Also, food products such as mustard, mayonnaise, jelly, pudding, ketchup, etc., might also be dispensed according to the embodiments set out herein. This, when the term “liquid” is used herein, that term should be broadly construed to include any of the foregoing and other liquids with some amount of viscosity.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-400, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A device for dispensing a liquid from an elastic container having an opening and an interior, comprising:
(a) a cap having a flat lower face, an upper face, and an exterior surface;
(b) an attaching member on said upper face of said cap positionable to be in mechanical communication with said opening of said elastic container and providing sealing of said opening when so positioned;
(c) a one-way dispensing valve on said upper face of said cap and within said attaching member, said dispensing valve in fluid communication with said interior of said container,
wherein said dispensing valve is configured to allow passage of the liquid therethrough when the container is compressed and to block passage of the liquid therethrough when the container is not compressed;
(d) a dispensing aperture on said exterior surface of said cap and in fluid communication with said dispensing valve, said dispensing aperture at least for dispensing the liquid from the container when it is compressed;
(e) a one-way air recovery valve on said upper face of said cap and within said attaching member, said air recovery valve in fluid communication with said interior of said container, said air recovery valve configured to allow a passage of air into said interior of said container when the container is released from compression and blocking passage of the liquid therethrough when the container is compressed; and
(f) an air recovery vent in fluid communication with the exterior of the attaching member and with the air recovery valve, said air recovery vent providing for a passage of air to said air recovery valve when said container is released after it has been compressed.

2. The device for dispensing a liquid from an elastic container having an opening according to claim 1, wherein said attaching member is a threaded cylinder.

3. The device for dispensing a liquid from an elastic container having an opening according to claim 1, wherein said is located on said exterior of said cap.

4. The device for dispensing a liquid from an elastic container having an opening according to claim 3, wherein said dispensing aperture and said air recovery vent are in close proximity with each other.

5. The device for dispensing a liquid from an elastic container having an opening according to claim 4, further comprising:
(g) a removable adhesive seal affixed

6. The device for dispensing a liquid from an elastic container having an opening according to claim 1, wherein the liquid is a shampoo, a soap, a lotion, a styling gel, mustard, mayonnaise, a jelly, or a pudding.

7. The device for dispensing a liquid from an elastic container having an opening according to claim 1, wherein the dispensing valve is a duckbill valve or an umbrella valve.

8. The device for dispensing a liquid from an elastic container having an opening according to claim 1, wherein said dispensing valve is within said attaching member and wherein claim 1 further comprises:
(g) a conduit between said dispensing valve and said dispensing aperture.

9. The device for dispensing a liquid from an elastic container having an opening according to claim 1, wherein the air recovery valve is situated on the exterior surface of the cap.

10. The device for dispensing a liquid from an elastic container having an opening according to claim 9, wherein the air recovery valve is rotatable between an open and a closed configuration.
